(19) United States
(12) Patent Application Publication
(10) Pub. No.: US 2002/0114030 A1
(43) Pub. Date: Aug. 22, 2002

(54) Optical transmission systems including optical multi-casting systems, apparatuses,and methods

(75) Inventors: Anarug Dwivedi, Ellicott City, MD (US); Harrison K. Roberts, Columbia, MD (US); David R. Huber, Glenwood, MD (US)

Correspondence Address: CORVIS CORPORATION, INTELLECTUAL PROPERTY DEPARTMENT, 7015 ALBERT EINSTEIN DRIVE, COLUMBIA, MD, 210469400

(73) Assignee: Corvis Corporation

(21) Appl. No.: 10/071,030

(22) Filed: Feb. 8, 2002

Related U.S. Application Data
(60) Provisional application No. 60/267,367, filed on Feb. 8, 2001.

(51) Int. Cl. H04B 10/20; H04J 14/00; H04B 10/00

(52) U.S. Cl. 359/118; 359/154

(57) ABSTRACT

A transmission system, including a content server, an optical transmitter having an input connected to the content server and having an output for producing optical signals indicative of content on the server, an optical switching device for selectively multi-casting optical signals, and a plurality of optical receivers connected to the switching device and receiving multicast optical signals. The optical switching device may further include an optical duplicator having an input connected to the output of the transmitter and having a plurality of outputs, and a plurality of separately controllable optical switching elements connected to the outputs of the optical duplicator.

### CROSS-REFERENCE TO RELATED APPLICATIONS

This application is a continuation-in-part of U.S. Provisional Patent Application No. 60/267,367, which was filed on Feb. 8, 2001.

### STATEMENT REGARDING FEDERALLY SPONSORED RESEARCH OR DEVELOPMENT

Not Applicable

### BACKGROUND OF THE INVENTION

The present invention is directed generally to optical transmission systems. More particularly, the invention relates to optical transmission systems that multi-cast optical signals.

Digital technology has provided electronic access to vast amounts of information. The increased access has driven demand for faster and higher capacity electronic information processing equipment (computers) and transmission networks and systems to link the processing equipment.

In response to this demand, communications service providers have turned to optical communication systems, which have the capability to provide substantially larger information transmission capacities than traditional electrical communication systems. Information can be transported through optical systems in audio, video, data, or other signal formats analogous to electrical systems. Likewise, optical systems can be used in telephone, cable television, LAN, WAN, and MAN systems, as well as other communication systems.

Early optical transmission systems, known as space division multiplex (SDM) systems, transmitted one information signal using a single wavelength in separate waveguides, i.e. fiber optic strand. The transmission capacity of optical systems was increased by time division multiplexing (TDM) multiple low bit rate, information signals, such as voice and video signals, into a higher bit rate signal that can be transported on a single optical wavelength. The low bit rate information carried by the TDM optical signal is separated from the higher bit rate signal following transmission through the optical system.

The continued growth in traditional communications systems and the emergence of the Internet as a means for accessing data has further accelerated the demand for higher capacity communications networks. Telecommunications service providers, in particular, have looked to wavelength division multiplexing (WDM) technologies to further increase the capacity of their existing systems.

In WDM transmission systems, pluralities of distinct TDM or SDM information signals are carried using electromagnetic waves having different wavelengths in the optical spectrum. Presently, most WDM systems employ wavelengths in the infrared range of the spectrum to carry information. Multiple information carrying wavelengths are combined into a multiple wavelength, or WDM, optical signal that is transmitted in a single waveguide. In this manner, WDM systems can increase the transmission capacity of existing SDM/TDM systems by a factor equal to the number of wavelengths used in the WDM system.

Until recently, optical WDM systems were deployed only as point-to-point WDM optical links (“P2P-WDM”) used to interconnect electrical switching and regeneration sites. At the electrical interconnection sites in the P2P-WDM systems, each information carrying wavelength in the WDM signals is converted to electrical signals for processing. Electrical signals can be dropped and/or added, entirely or in part depending upon the signal protocol and granularity, at the site and signal processing can be performed as necessary. If no signal processing is required, the signal is merely regenerated and retransmitted on nominally the same or a different wavelength along the same fiber path or switched to a different fiber path.

As might be expected, it can become extremely expensive and inefficient to perform optical to electrical to optical conversions in P2P-WDM systems merely to pass signals along to the transmission path. The cost of electrical regeneration/switching in WDM systems will only continue to grow with WDM systems having increasing numbers of channels and transmission paths in the system. In addition, the complexity of these systems will continue to increase exponentially due to the individual handling of each wavelength in the system. As such, there is a desire to eliminate unnecessary, and costly, electrical regeneration and switching equipment from the network.

In addition, the service provider industry has encountered a number changes in the types of traffic that must be supported in their networks. Traditional revenue generating services, namely voice traffic, now represents a continually decreasing percentage of the total traffic demand. Service provider competition also has reduced substantially the premiums that can be charged for these traditional services. Service providers are now looking to develop innovative revenue generating service delivery, such as short term circuit leasing, etc. to support their businesses.

Typical optical communication systems are not truly all optical because at certain intervals the optical signals are converted to electrical signals, processed, and then retransmitted as optical signals. This electrical conversion adds cost and complexity to the system . Electrical conversion also adds latency to the system because the information must be buffered and processed during the regeneration process. In addition, typical systems convert the optical signals to electrical signals to perform signal switching, which again increases cost, complexity, and latency. Therefore there is a need for all optical multi-casting in order to decrease cost, latency, and complexity in optical networks.

In view of the changes in traffic demands, it has become necessary to deploy transmission systems, in which unnecessary equipment and operating costs are eliminated and innovative services such as all optical multi-casting can be enabled.

### BRIEF SUMMARY OF THE INVENTION

The apparatuses and methods of the present invention address the above need for higher performance, more flexible transmission systems. Optical systems of the present invention generally include at least one multi-casting optical switching device, such as optical cross-connect switches and routers, as well as add/drop multiplexers, disposed along an optical path between at least one transmitter and multiple optical receiving nodes.

In various embodiments, the system includes at least one optical transmitter configured to transmit information through the optical system. The multi-cast switching device is configurable to multi-cast the information to receivers located in multiple optical processing nodes. The system allows the establishment of multiple short and/or long circuits using a single wavelength throughout the system, thereby enabling highly efficient services to multiple locations throughout a network.

In addition, the present invention allows circuits to be established or torn down, while maintaining other circuit connections. For example, a single information source at node A can be used to establish multiple circuits through the multi-cast switching device to diverse nodes B and C. If differing amounts of information need to be provided to nodes B and C, then the multi-cast switching device can be configured to establish and tear down circuits between the multi-cast switching device and nodes B and C, as necessary. Circuits, which are torn down, can be reused between the multi-cast switching device and other nodes during times when a circuit connection is not necessary. For example, the multi-cast switching device can switch the wavelength to provide information to node B from other nodes beside node A during times when information is not being sent from node A. In addition, the multi-cast switching device can be used to provide a common wavelength path between the multi-cast switching device and node A, which can be shared by nodes B and C, as necessary. The sharing can employ many techniques, ranging from periodic or on demand establishment of circuits for poling or other short term uses to continuous transmission between the nodes.

In various embodiments, a plurality of geographically diverse, i.e., remotely located, nodes can include storage network devices, which can be interconnected via the multi-cast switching device to form a storage area network (“SAN”). The storage network devices can include information, or “content”, servers and/or storage devices. In the present invention, the multi-cast switching device provides for communication of information from one storage network device to one or all other storage network devices in the network using one or more common wavelengths.

In one configuration, a storage network device can be configured to send information using a single wavelength, which can be multi-cast to a plurality of storage network devices that require the information. The number of storage network devices connected by the multi-cast switching device at any one time can be varied to match the information requirements of the individual storage network devices.

In an exemplary application, an information server and/or central storage facility provides the information to an optical transmitter. The transmitter transmits the information using one signal wavelength, or signal channel, through the optical system to the multi-cast switching device. The multi-cast switching device is configured to multi-cast the signal channel to geographically diverse content storage and/or server locations. In addition, the multi-cast switching device, in particular, and the optical system, in general, can be configured to allow service providers to establish the multi-cast circuits, only as necessary to update the remote locations. These embodiments allow for one or more dynamic storage area networks to be established without consuming significant network resources.

The aforementioned examples reference communication between remote storage network devices. However, it will be appreciated that commonly located redundant or back-up storage and/or server devices can be deployed in these embodiments.

In various storage area network embodiments, a central storage facility or content generator, such as a centralized Internet content or corporate data center, can employ a single wavelength to update all redundant and remote facilities in a network. This allows size of the storage area network to be increased without requiring the network capacity to scale with the number of storage network devices. The multi-cast switching device can be used to establish connections between one or more of the nodes in multi-cast and/or single circuit connection, as may be necessary in the particular application of the present invention.

It will be appreciated that each node in the storage area network can be considered a central facility for some information including applications and/or content and a remote facility for other information. In various embodiments, duplex circuits can be established to provide two way communication between redundant storage facilities with diverse content generators. Also, some embodiments may deploy signaling to request or verify the transmission and receipt of information.

The present multi-casting invention can also be used, for example, in systems for video production, digital cinema distribution, on-demand movies, cable TV distribution, gaming, telemedicine, remote learning, instant messaging, disaster recovery, distributed computing, streaming media, and the broadcast of special events. In addition, the present invention can be used in systems where mutli-casting is necessary.

The preceding description has been provided using a single wavelength to provide communication between multiple nodes to simplify the explanation. However, the invention applies equally to using multiple wavelengths to provide the communications including both simplex and duplex connectivity between the nodes. The present invention provides the flexibility to tailor the bandwidth requirements of the network to the actual capacity requirements of the storage network devices and devices used in other multicasting applications. In simplex applications there is often need for a smaller (asymmetric) bandwidth in the reverse direction for purposes such as signaling, and acknowledgement. This could be accomplished by either in-band or out-of band bandwidth. Out-of-band reverse signaling could be engineered using IP based, multi-data channel based, phone line, or a fax line based bandwidth. In-band signaling for a simplex application (say direction A to B) could be achieved by using the portion of reverse bandwidth (B to A) in the same channel for signaling and rest of the bandwidth from B to A for another simplex application.

Accordingly, the present invention addresses the aforementioned needs by providing optical systems, apparatuses, and methods with increased flexibility and scalability. These advantages and others will become apparent from the following detailed description.

### BRIEF DESCRIPTION OF THE DRAWINGS

Embodiments of the present invention will now be described, by way of example only, with reference to the accompanying schematic drawings for the purpose of illustrating embodiments only and not for purposes of limiting the same, wherein:

FIGS. 1 and 2 illustrate optical system embodiments;

FIGS. 3, 4, 5, and 6 illustrate multi-cast switching device embodiments;

FIG. 7 illustrates a storage area network using multi-cast switching; and

FIG. 8 illustrates a cable network using multi-cast switching.

### DESCRIPTION OF THE INVENTION

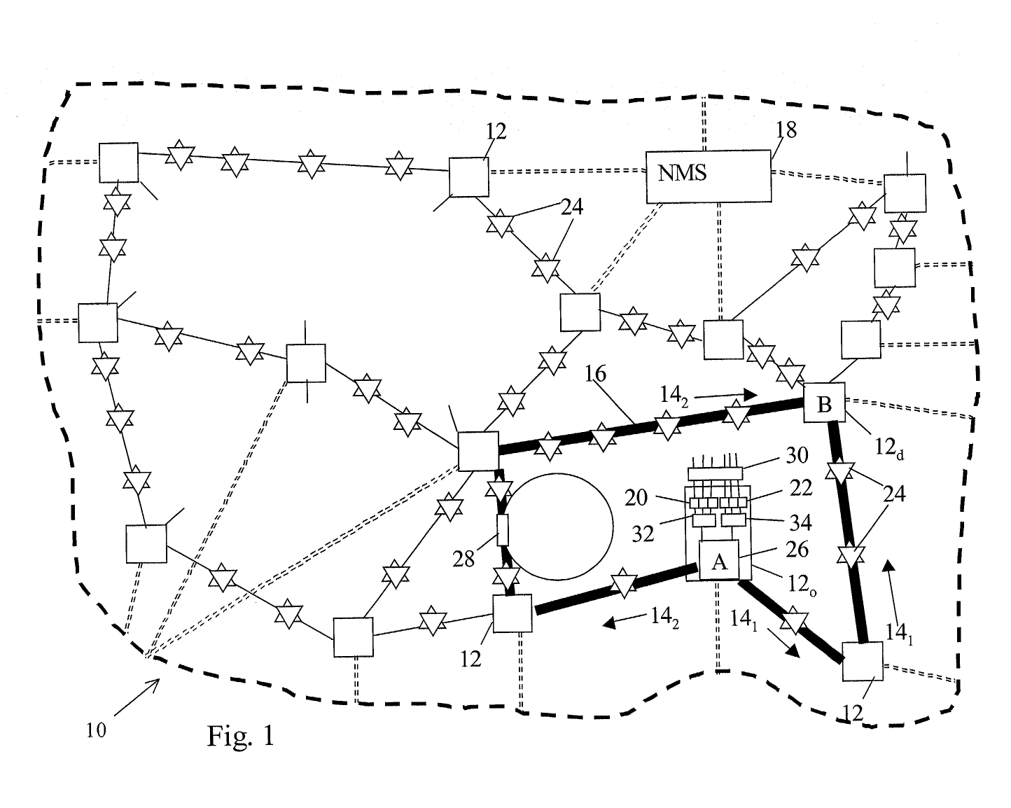

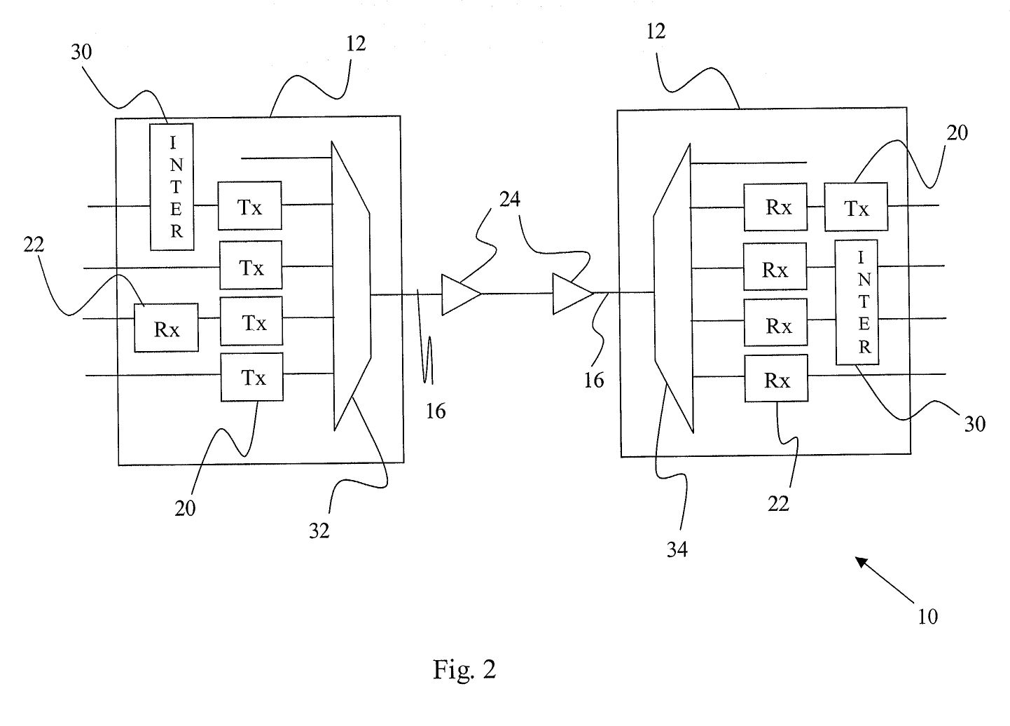

FIG. 1 illustrates an optical system 10, which includes a plurality of nodes 12 connected by optical communication paths 14. The system 10 is illustrated as a multi-dimensional network, although advantages of the present invention may be realized with other system 10 configurations, such as one or more serially connected point to point links, as shown in FIG. 2. The system 10 may support one or more transmission schemes, such as space division multiplexing, time division multiplexing, wavelength and frequency division multiplexing, etc., singly or in combination within a network to provide communication between the nodes 12.

As shown in FIG. 1, optical processing nodes 12 generally can include various optical components, such as transmitters 20, receivers 22, amplifiers 24, optical switches 26, optical add/drop multiplexers 28, interfacial devices 30, storage devices, and content servers. For example, in WDM embodiments, the node 12 can include optical switches 26 and interfacial devices 30 along with multiple transmitters 20, receivers 22, and associated equipment, such as monitors, power supplies, etc.

In various network embodiments, multiple paths, e.g., 141 and 142, can be provided between nodes 12. The optical path 14 between adjacent nodes 12 is referred to generally as an optical link. The optical communication path 14 between adjacent optical components along the link is referred to as a span.

Various guided and unguided transmission media 16, such as fiber, planar, and free space media, can be used to form the optical communication circuits or paths 14. The media 16 supports the transmission of information between originating nodes 12o and destination nodes 12d in the system 10. As used herein, the term “information” should be broadly construed to include any type of data, instructions, or signals that can be transmitted.

The transmission media 16 can include one or more optical fibers interconnecting the nodes 12 in the system 10. Each fiber typically can support either unidirectional or bidirectional transmission of optical signals in the form of one or more information carrying optical signal wavelengths λ, or “channels”. The optical signal channels in a particular path 14 can be processed individually, or organized and processed in two or more wavebands, each containing one or more optical signal channels.

A network management system (“NMS”) 18 can be provided to manage, configure, and control optical components in the system 10. The NMS 18 generally includes multiple management layers, some of which can reside at one or more centralized locations and others can reside with the optical components. The optical components can be grouped logically as network elements for the purposes of network management. One or more network elements can be established at each optical component site in the network depending upon the desired functionality in the network and management system.

The NMS 18 can be connected directly or indirectly to network elements located either in the nodes 12 or remotely from the nodes 12. For example, the NMS 18 may be directly connected to network elements in the nodes 12 via a wide area network (shown in broken lines) or data communication network. Indirect connections to remote network elements can be provided through network elements with direct connections by transmitting supervisory information along one or more optical communication paths 14 between the network elements.

The optical transmitters 20 transmit information as optical signals via one or more signal channels λ through the transmission media 16 to optical receivers 22 located in other processing nodes 12. The transmitters 20 used in the system 10 generally includes an optical source that provides optical power at one or more optical carrier wavelengths. The optical source can include various coherent narrow or broad band sources, such as DFB and DBR lasers, sliced spectrum sources and fiber and external cavity lasers, as well as suitable incoherent optical sources, e.g., LED, as appropriate.

Information can be imparted to the optical carrier either by directly modulating the optical source or by externally modulating the optical carrier emitted by the source. Alternatively, the information can be imparted to an electrical carrier that can be upconverted onto an optical wavelength to produce the optical signal. Electro-optic (e.g., LiNbO3), electro-absorption, other types of modulators and upconverters can be used in the transmitters 20.

In addition, the information can be imparted using various modulation formats. For example, various amplitude modulation schemes, such as non-return to zero (NRZ) and return to zero (RZ) using various soliton and pulse technologies. Various frequency and phase modulation techniques also can be employed.

The optical receiver 22 used in the present invention can include various detection techniques, such as coherent detection, optical filtering and direct detection, and combinations thereof. The receivers 22 can be deployed in modules that have incorporated wavelength selective filters to filter a specific channel from a WDM signal or channel filtering can be performed outside of the receiver module. It will be appreciated that the detection techniques employed in the receiver 22 will depend, in part, on the modulation format used in the transmitter 20.

Generally speaking, N transmitters 20 can be used to transmit M different signal wavelengths to J different receivers 22. Also, tunable transmitters 20 and receivers 22 can be employed in the optical nodes 12 in a network, such as in FIG. 1, to allow the signal wavelengths in the system 10 to be varied according to network requirements.

In addition, the transmitters 20 and receivers 22 can include various components to perform other signal processing, such as reshaping, retiming, error correction, differential encoding, etc. For example, receivers 22 can be connected to the transmitters 20 in back to back configuration as a regenerator, as shown in FIG. 2. The regenerator can be deployed as a 1R, 2R, or 3R regenerator, depending upon whether it serves as a repeater (repeat), a remodulator (reshape & repeat), or a full regenerator (reshape, retime, repeat).

The optical amplifiers 24 can be deployed periodically along optical links 15 to overcome attenuation that occurs in a span of transmission media 16. In addition, optical amplifiers 24 can be provided proximate to other optical components, for example, at the node 12 to provide gain to overcome component losses. The optical amplifiers 24 can include doped (e.g. erbium) and non-linear interaction (e.g., Raman) fiber amplifiers that can be pumped locally or remotely with optical energy, as well as other types of optical amplifiers, such as semiconductor amplifiers.

The optical amplifiers 24 can include one or more serial and/or parallel stages that provide localized gain at discrete sites in the network and/or gain that is distributed along the transmission media 16. Different amplifier types can be included in each stage and additional stages to perform one or more other functions. For example, optical regeneration, dispersion compensation, isolation, filtering, add/drop, etc. can be included at a site along with the optical amplifier 24.

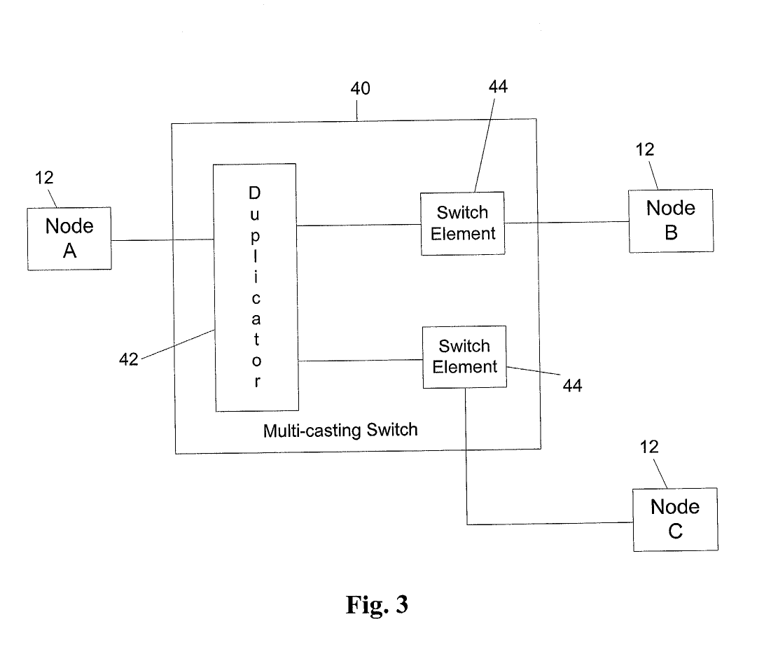

Various optical switches 26 and OADMs 28 (“switching devices”) can be employed in the network, as will be later described with reference to FIGS. 3-8. For example, the switching devices can be configured to process individual signal channels or signal channel groups including one or more signal channels. The switching devices also can include various wavelength selective or non-selective switch elements. The OADMs 28 can include wavelength reusable and non-reusable configurations. Similarly, the switching devices can be configured to provide multi-cast capability, as well as signal channel terminations, as will be further described.

The interfacial devices 30 may include, for example, protocol independent devices, such as optical switches, as well as protocol dependent electrical switch devices, such as IP routers, ATM switches, SONET add/drop multiplexers, etc. The interfacial devices 30 can be configured to receive, convert, and provide information in one or more various protocols, encoding schemes, and bit rates to one or more transmitters 20, and perform the converse function for the receivers 22. The interfacial devices 30 also can be used as an input/output cross-connect switch or automated patch panel and to provide protection switching in various nodes 12 depending upon the configuration. The interfacial devices 30 can be electrically connected to the transmitters 20 and receivers 22 or optically connected using standard optical interface transmitters and receivers, as previously described.

Optical combiners 32 can be provided to combine optical signals from multiple paths into a WDM signal on a common path, e.g. fiber, such as from multiple transmitters 20 or in a switching device. Likewise, optical distributors 34 can be provided to distribute one or more optical signals from a common path to a plurality of different optical paths, such as to multiple receivers 22 or in a switching device.

The optical combiners 32 and distributors 34 can include wavelength selective and non-selective (“passive”) fiber and free space devices, as well as polarization sensitive devices. For example, one or more multi-port devices, such as passive, WDM, and polarization couplers/splitters having various coupling/splitting ratios, circulators, dichroic devices, prisms, diffraction gratings, arrayed waveguides, etc. can be employed used in the combiners 32 and distributors 34. The multi-port devices can be used alone, or in various combinations of filters, such tunable or fixed, high, low, or band pass or band stop, transmissive or reflective filters, such as Bragg gratings, Fabry-Perot, Mach-Zehnder, and dichroic filters, etc. Furthermore, one or more serial or parallel stages incorporating multi-port device and filter combinations can be used in the combiners 32 and distributors 34 to multiplex, demultiplex, and multi-cast signal wavelengths λᵢ in the optical systems 10.

In the present invention, at least one optical switching device 26/28 is embodied as a multi-cast switching device 40. The multi-cast switching device 40 can be configured to receive one or more signal channels at an input port and pass the signal channels to a plurality of output ports.

In FIG. 2, it will be appreciated that the transmitters 20 and receivers 22 can be used in WDM and single channel systems, as well as to provide short, intermediate, and/or long reach optical interfaces between other network equipment and systems. For example, transmitters 20 and receivers 22 deployed in a WDM system can be included on a module that also includes standardized interface receivers and transmitters, respectively, to provide communication with interfacial devices 30, as well as other transmission and processing systems.

FIG. 3 illustrates a multi-cast switching device 40 embodiment in a system 10, in which a plurality of all-optical circuits can be established through the system 10 to deliver information to multiple destinations. The multi-cast switching device 40 generally will include an optical duplicator 42, such as a splitter, to duplicate optically an input signal and provide a desired plurality of signals. It will be appreciated that it is not required that the duplicate signals have the same optical power, only that the information carried by the optical signal be duplicated.

The multi-cast switching device 40 also includes switch elements 44 that can be configured to pass or block the signals destined for the various other nodes 12 in a selective manner bases upon a control signal received at a control input. Typically, the switch elements 44 will follow the duplicator 42 to provide individual control over each of the divided signals. The switch elements 44 may be controlled by the network management system 18 to control which nodes receive the multi-cast signal. However, the switch elements 44 can be positioned preceding the duplicator 42 with appropriate modification to the optical circuits.

The duplicating and switching of the signals can be performed at varying granularities, such as line, group, and channel switching, depending upon the degree of control desired in the system 10. The switch element 44 can include wavelength selective or non-selective on/off gate switch elements 44, as well as variable optical attenuators having suitable extinction ratios. The switch elements 44 can include single and/or multiple path elements that use various techniques, such as polarization control, interferometry, holography, etc. to perform the switching and/or variable attenuation function. Various optical switch embodiments can be employed as the multi-cast switching device 40, such as those described in PCT Publication No. WO 00/05832 and related U.S. patent application Ser. No. 09/119,562 filed Jul. 21, 1998, which are incorporated herein by reference.

The multi-cast switching device 40 can be configured to perform various other functions, such as filtering, power equalization, telemetry, channel identification, etc., in the system 10. For example, the switch elements 44 can employ variably attenuating on/off gates to perform power equalization, in addition to on/off switching.

In FIG. 3, the multi-cast switching device 40 embodiment is depicted as multi-casting a signal wavelength λ₁ transmitted from at least one node 12 (“A”) to a plurality of other nodes 12 (“B&C”) disposed in the system 10. This embodiment allows a single wavelength to be used to transmit information to multiple nodes 12, which substantially decreases the capacity required in the system 10 to update or mulit-cast to each of the multiple nodes.

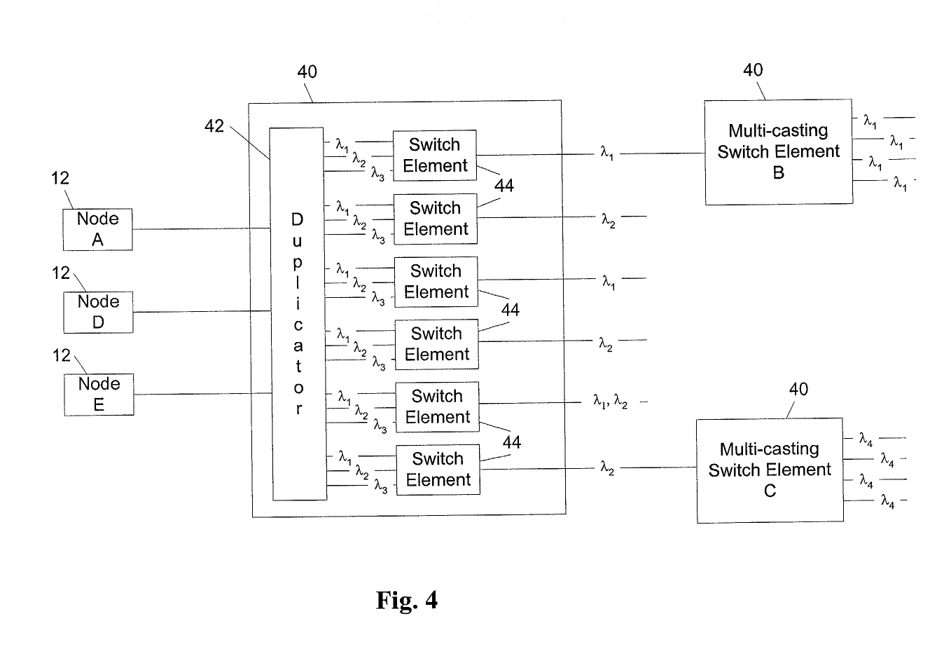

FIG. 4 is another embodiment of the present inventions. Three nodes 12 A, D, and E provide three different information streams on three different wavelengths λ₁, λ₂, and λ₃ respectively to the multi-cast switching device. The duplicator 42 duplicates each of different wavelengths λ₁, λ₂, and λ₃ and provides them to each of the switch elements 44. The duplicator may be a distributor 34 as described above and may include active or passive devices. The duplicator may include amplification to amplify either the incoming or outgoing signals so that the output signals are of sufficient power to further propagate through the switch elements 44. The switch elements 44 can then output any of the three input wavelengths or a combination thereof as shown at the output of the switch elements 44.

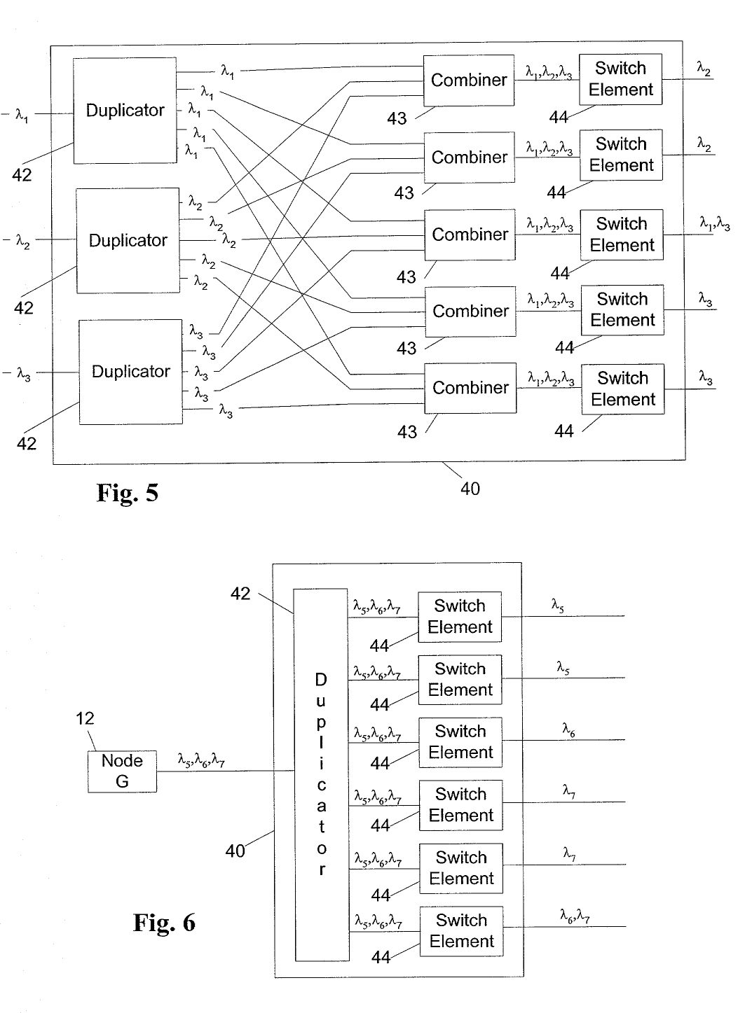

FIG. 5 illustrates another embodiment of the multi-casting switch element 40 that combines the different wavelengths λ₁, λ₂, and λ₃ to supply a single combined optical signal to each of the switch elements 44. The duplicators 42 each receive and duplicate a different wavelength signal. Combiners 43 receive the duplicated signal from each of the duplicators and combine the different wavelengths together. The combiner transmits the combined wavelengths to each switch element 44. The switch element can then output any of the three input wavelengths or a combination thereof.

Further, it is possible to cascade multi-casting switching devices 44 to multi-cast a signal to a larger number of destinations. Multi-casting switching device 40B receives the output of multi-casting switching device 40F. The cascaded mulit-casting switching devices 40 may either be co-located or remotely located with one another. In addition, a multi-casting switching device can receive information on an input signal wavelength λ₂ and multi-cast the information on a different wavelength λ₄. In addition, wavelength conversion of the optical signal may be performed before or after the multi-cast switching device 40. As such, the information may reach the various destinations on different wavelengths depending on the system configuration.

It also will be appreciated that multiple wavelengths could be used to transmit information to the multiple nodes 12. For example, if nodes 12 were generating an information stream in excess of the single wavelength capacity in the system 10. Also, it may be more cost effective to establish multiple multi-cast circuits for a shorter period of time, then would be required to transmit the information using a single wavelength.

FIG. 6 is another embodiment of the present invention. A node 12 provides a single signal with three different information streams on three different wavelengths λ₅, λ₆, and λ₇. The duplicator duplicates signal and provides it to each of the switching elements 44. The switching elements as before can output any of the individual wavelengths or any combination thereof.

In various networks, such as fully redundant storage applications, the multi-cast switching device 40 multi-casts all of the information to each node 12. In other operations, such as distributed redundancy storage applications, only a portion of the information transmitted may be destined for each node. The information can be extracted by each node, as necessary.

Similarly, the multi-cast switching device 40 can be used to establish and tear down multi-cast circuits to a plurality of nodes 12 on a periodic basis or on demand. As such, a single wavelength can be used to send out information to a plurality of nodes 12 in a parallel and/or serial fashion depending upon the information being transmitted. In addition, a substantial decrease in the capacity required to perform restoration and/or protection can be achieved via the multi-cast distribution.

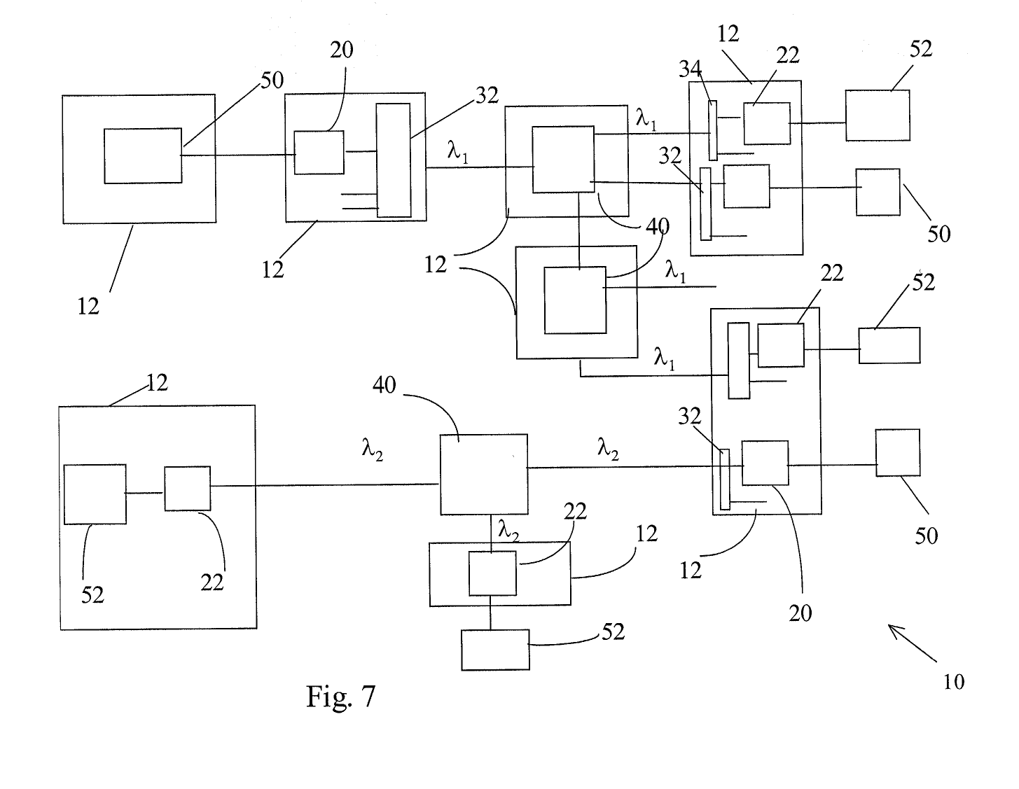

FIG. 7 shows an exemplary embodiment of the present invention enabling a high efficiency, storage area network (“SAN”). One or more content servers 50 can simultaneously transmit information to update a plurality of storage devices 52 throughout the system 10 with each server using a single wavelength. The multi-cast switching devices 40 in the system 10 are configured to multi-cast the wavelength λ₁ carrying the information to the plurality of storage devices 52.

It may be desirable to some applications to provide for duplex communication between the various nodes 12 for various purposes; for example, “acknowledgment, “need for resend”, and other nodal communications. The return communication can be carried in band on the optical network or out of band on another network in order to maximize the efficiency of the overall network.

It will be appreciated that each node 12 in the storage area network can be considered a central facility for some information including applications and/or content, and a remote facility for other information. The multi-cast switching device 40 can be used to establish connections between one or more of the nodes in multi-cast and/or single circuit connection, as may be necessary in various applications of the present invention.

In various embodiments, simplex or duplex circuits can be established between redundant storage facilities for one or more content servers 50. Also, some embodiments may employ signaling to request or verify the transmission and receipt of information. For example, Internet content distribution or corporate data centers may have a plurality of diverse, redundant content storage facilities, which can be updated by one or more content generators to include unique or duplicative data. The signaling between the diverse sites and the content server 50 for the information can be performed using various bit rate signals. In addition, the signaling can be performed continuously, such as by providing “heartbeat” monitoring of the remote facilities, or by periodic or on-demand poling of the facilities. Again, this signaling can be performed in band in the optical network or out of band.

In one embodiment, the SAN 54 of FIG. 7A may include redundant storage devices 52 for storing backup copies of data, such as to assist in disaster recovery. Multiple copies of data would be stored at various storage devices 52. Updates to the data would be broadcast from the content providers 50 to each of the various storage devices 52. Users of the data can then access any of the various storage devices 42 to retrieve needed information. If one of the of the storage devices 52 is corrupted, users can easily access the data from other operating storage devices 52. The storage devices 52 may be geographically dispersed to prevent a single disaster from affecting all of the storage 25 devices 52. Upon recovery from the disaster, the SAN 54 can then be used to restore the data to the corrupted storage device 52.

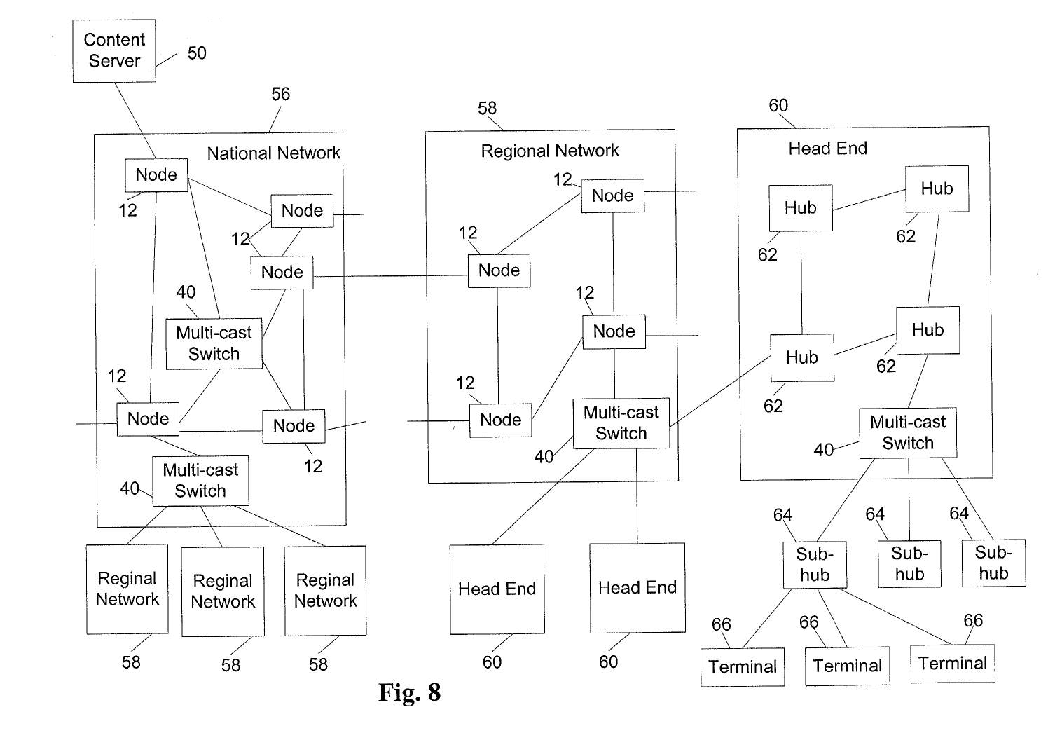

FIG. 8 is another embodiment of the present invention that illustrates the distribution of content over several network layers. In that example, a content server 50 transmits content to a backbone network 56, such as a national long haul network, which 30 transmits the content to several smaller networks 58, such as a regional network, which transmit the content to several head ends 60. Each head end 60 transmits the content to sub-hubs 64 that transmit the content to terminals 66. At the terminals 66 the user is able to view and/or use to content. Each network layer may utilize one or more multi-casting switch devices 40 to facilitate content distribution, or some network layers may not utilize any multi-casting switch devices 40. The networks may be optical networks or electrical networks or combinations of the two. For example, an optical backbone network 56 may be connected to several electrical coaxial cable networks via optical or electrical smaller networks 58.

In one example, the content server provides content on an optical channel in a WDM system. That wavelength may be provided to one or more smaller networks 58, each of which may provide the content to one more head ends 60. Alternatively, the content server 50 may provide more than one optical channels, each of which may be provided to successive network layers. In other embodiments, more than one content server 50 may be connected, directly or indirectly, to the backbone network 56. In other examples, different types and numbers of networks may employ the present invention. For example, content servers 50 may be utilized by smaller networks 58 without assistance from backbone networks 56, or by head ends 60 with assistance from smaller networks.

The content server 50 stores or receives content to be provided to a user. The content may be, for example, broadcast and cable television programming, video on demand (including near video on demand or quantized video on demand), special events, sports programming, educational programming, or any other programming that is widely broadcast. Alternatively, the content can be more user specific, such as Internet services. The content server may serve only one type of content or may group various types of content together for transmission. For example, various groups of broadcast programming corresponding to different user packages (e.g., cable television packages) may be broadcast together. Also, additional content, such as video on demand, may be added to the content. The content server 50 may provide content in various formats, such as optical or electrical, depending on the particular application. The content server 50 may be connected directly or indirectly to the backbone network 56, such as via one or more smaller networks 58, local networks, or other connections.

The backbone network 56 is typically a high bandwidth, long haul, backbone network. The backbone network 56 receive content from one or more content servers 50 for transmission and distribution. The backbone network 56 may consist of rings, point-to-point links, a mesh architecture, or other types or combinations of network architectures. The backbone network 56 may provide the content to various smaller networks 58. The backbone network will typically have a number of nodes 12 that are interconnected, and one or more nodes will include a multi-casting switch device 40. This multi-casting switch device 40 may receive content directly from the content server, or from another node 12 in the backbone network 56 and multi-cast the content to a number of other nodes 12 within the backbone network 56 or outside the backbone network, such as to smaller networks 58. In addition, the multi-casting switch device 40 may act as a node 12 itself or be part of a node including other optical devices and systems.

The smaller networks 58 distribute content in a region. While the smaller network 58 is shown as a ring network, it may also consist of other network architectures, such as point-to-point, mesh, combinations, or other network architectures. The smaller network 58 has a number of nodes 12 arranged for the distribution of content. One or more nodes 12 may include or be connected to multi-casting switch devices 40 that multi-casts information to a number of head ends 60. The multi-casting switch devices 40 may stand alone from a node 12, be a part of a node 12, or be a node 12 itself in the network. Also, a multi-casting switch device 40 may be used with in the smaller network to multi-cast certain content to selected nodes in the smaller network as was done in the backbone network 58.

The head ends 60 receive the content from the smaller network for input into the cable plant of the cable operator. The head ends 60 will have a number of inter-connected hubs. Each hub is connected to a number of sub-hubs 64. The sub-hubs 64 connect to a number of terminals 66. It is at the terminals 66 that the end user receives the content for use. Any content that is delivered optically through the head end 60, hubs 62, and sub-hubs 64 may use the multi-casting switch 40 devices to further multi-cast content.

Information may also be transmitted in the opposition direction of that previously described. For example, the user at the terminal 66 may make a request for content, such as video on demand, and that request would flow back through the network. The user request may be acted on at the any of the network levels, such as at the head ends 60, in the smaller network 56, in the backbone network 58, or at the content server 50. For example, if the desired content is available at the head end 60, the content may be directed to the used without the request traveling beyond the head end 60. In contrast, if the content is not available at the head end 60, the request may be forwarded, or bundled with other requests, to the smaller network 56, backbone network 58, or content server 50, as appropriate. In addition, the users request may be transmitted out-of-band through an alternate network to the appropriate network level to allow a multi-cast switch device 40 to multi-cast the desired content to the terminal 66.

Through out the cable network 53 the various multi-casting switch devices 40 may operate as previously described in FIGS. 3-6. For example, the multi-casting switch devices 40 may combine and multi-cast a number of wavelengths together. A multi-casting switch device 40 may receive multiple wavelengths and multi-cast each wavelength or combinations thereof to different groups of nodes. Also, the multi-casting switch devices 40 may include wavelength translation devices in order to avoid wavelength collisions as wavelengths move from one network to another.

In the present invention the NMS 18 functions to control the multi-casting throughout the network. The NMS 18 controls the flow of information throughout the network to allow data to be multi-cast to various recipients. The NMS 18 manages the transmission wavelengths and determines when wavelength translation may be necessary. Also, the NMS 18 would manage the aggregation of content to be multi-cast. The NMS 18 may function to manage the whole cable network 53, or each of the various levels may have individual NMS's 18 to manage each network level, and the individual NMS's 18 would interface with one another to allow overall control and operation of the cable network 53.

Those of ordinary skill in the art will appreciate that numerous modifications and variations can be made to specific aspects of the present invention without departing from the scope of the present invention. It is intended that the foregoing specification and the following claims cover such modifications and variations.

What is claimed is:

1. A transmission system, comprising:
a content server;
an optical transmitter having an input connected to the content server and having an output for producing optical signals indicative of content on the server;
an optical switching device for selectively multi-casting optical signals, including:
an optical duplicator having an input connected to the output of the transmitter and having a plurality of outputs;
a plurality of separately controllable optical switching elements connected to the outputs of the optical duplicator;
a plurality of optical receivers connected to the switching device and receiving multicast optical signals.

2. The system of claim 1, wherein the optical switching device is configured to transmit multi-cast the information to less than all of the optical receivers.

3. The system of claim 1, wherein the optical transmitter is configured to transmit all of the multicast signals on a single wavelength.

4. The system of claim 1, wherein the transmitter is configured to transmit the multicast signals on a plurality of wavelengths.

5. The system of claim 1, further comprising a plurality of storage devices connected to the receivers and forming a storage area network.

6. The system of claim 5, wherein the storage area network includes a plurality of transmitters for transmitting signals indicative of the status of the storage area network.

7. The system of claim 1, further comprising a cable box connected to one of the receivers.

8. The system of claim 7, wherein the cable box includes a transmitter for transmitting content requests back into the system.

9. The system of claim 8, wherein the content server provides video on demand services.

10. The system of claim 1, wherein:
the optical signals are transmitted on a plurality of wavelengths;
the switching device includes:
a plurality of duplicators corresponding to the plurality of wavelengths;
a plurality of combiners, each combiner having a plurality of inputs and an output, wherein each combiner receives an input from each duplicator and wherein the output of each combiner is connected to a switch element.

11. A communications network, comprising:
a content server;
an optical network including a plurality of nodes connected by optical transmission media, wherein at least one node is connected to the content server;
an optical switching device for selectively multi-casting optical signals, including:
an optical duplicator having an input connected to the output of the transmitter and having a plurality of outputs;
a plurality of separately controllable optical switching elements connected to the outputs of the optical duplicator;
a plurality of optical receivers connected to the switching device and receiving multicast optical signals;
an electrical network including a plurality of terminals;
an electrical transmitter connected to the optical receiver and transmitting electrical signals indicative of received optical signals;

12. The system of claim 11 wherein the optical network includes:
an optical backbone network; and
a plurality of smaller optical networks, wherein the smaller optical networks are connected to the optical backbone networks through a plurality of nodes.

13. The system of claim 12, further comprising a head end between the electrical network and one of the smaller networks.

14. The system of claim 13, wherein the head end includes a plurality of hubs.

15. The system of claim 12 wherein the optical switching device receives content from a node in the backbone network.

16. The system of claim 12 wherein the optical switching device receives content from a node in the smaller network.

17. The system of claim 12 wherein the optical switching device receives content from a node in the national network.

18. A storage area network comprising:
a plurality of content servers;
a plurality of storage devices;
a first plurality of optical transmitters connected to the plurality of content servers and configured to transmit information from the content servers;
a second plurality of optical transmitters connected to the plurality of storage devices and configured to transmit information from the storage devices;
a plurality of optical receivers connected to the storage devices;
a plurality of optical switching devices for selectively multi-casting optical signals, wherein each optical switching device includes:
an optical duplicator having an input connected to an output of one of the transmitters and having a plurality of outputs;
a plurality of separately controllable optical switching elements connected to the outputs of the optical duplicator.

19. The network of claim 18, wherein each content server multi-casts information through one of the optical switching devices to one of the storage devices.

20. The network of claim 20, wherein each storage device multi-casts information through one of the optical switching devices to one of the storage devices.
